(19) United States
(12) Patent Application Publication
(10) Pub. No.: US 2026/0227801 A1
(43) Pub. Date: Aug. 6, 2026

(54) GENERATION OF DATA DURING THE TRANSFER OF AUTONOMOUSLY TRAVELLING HANGING BAGS INTO A HANGING-BAG STORE

(71) Applicant: EMHS GmbH, Pforzheim, DE (US)

(72) Inventors: Felix THEURER, Pforzheim (DE); Dominik GEYER, Keltern (DE); Christian GRAUBERGER, Pforzheim (DE); Michael Roland JAHNKE, Tettnang (DE); Frederic MÜLLER, Karlsruhe (DE); Viktor HERZOG-LANG, Keltern (DE); Laurin Vincent KRATEL, Vaihingen (DE); Rene BRADE, Eppingen (DE); Robin LUCKEY, Lübeck (DE)

(73) Assignee: EMHS GmbH, Pforzheim (DE)

(21) Appl. No.: 19/149,240

(22) PCT Filed: Jan. 19, 2024
(86) PCT No.: PCT/EP2024/051305

§ 371 Date: Jul. 18, 2025

(30) Foreign Application Priority Data
Jan. 19, 2023 (DE) 10 2023 000 184.8

(51) Int. Cl. G05D 1/667; G05D 1/646; G05D 107/70

(52) U.S. Cl. CPC G05D 1/667; G05D 1/646; G05D 2107/70

(57) ABSTRACT

The disclosure relates to a method for controlling hanging articles storage for storage articles to be stored hanging, wherein the hanging articles storage comprises a number of levels in each of which a network is provided, and a plurality of self-propelled transport vehicles, each having an article carrier attached or attachable hanging thereto for receiving a storage article, which can be moved independently of one another along the network.

### FIELD OF DISCLOSURE

The disclosure relates to a method for controlling a hanging articles storage for articles to be stored hanging, wherein the hanging articles storage comprises a number of levels, in each of which a network, in particular a rail network, is provided, and a plurality of self-propelled transport vehicles, each having an article carrier attached or attachable hanging thereto for receiving a storage article, which transport vehicle can be moved independently of one another along the network. Furthermore, the disclosure relates to a hanging articles storage for carrying out the method and to a hanging articles storage for articles to be stored hanging, which comprises a number of levels, in each of which a network is provided, and a plurality of self-propelled transport vehicles, each with an article carrier attached or attachable thereto for receiving a storage article, which can be moved independently of one another along the network.

### BACKGROUND

In automated article storages, production facilities and article transportation, such as in the mail order business, it is necessary to load articles into and unload them from containers as automatically as possible. The articles can be stored in these containers prior to delivery and are then transported to the station where they are packed for onward transportation to the customer. Transportation within the storage is usually carried out using hanging conveyor systems. The conveyed articles containers are usually bags that are made like fabric bags and are hanging from a rail system at the top with a type of wire bracket. Such a conveyed articles container is described, for example, in WO 2014/012965 A1. Its side wall elements are controlled via a linkage so that the side wall elements, which are connected to each other via a connecting area, can be opened. In the area of a loading station, the containers are also transferred to a horizontal or inclined position.

Comparable material containers and associated hanging conveyor systems are known, for example, from DE 10 2004 018 569 A1, EP 2 130 968 A1 or EP 2 196 415 A. The transport bags described there consist of flexible materials in the form of a loop in which the conveyed articles are held. For loading, these transport bags are opened from above so that the conveyed articles can be inserted into the loop. Unloading is achieved by either removing or ejecting the conveyed material from the side of the loop or by opening the loop downwards, for example in accordance with EP 2 130 968 A1. Furthermore, DE 103 54 419 A1 discloses a conveyed articles carrier that has a relatively rigid and flat plastic wall with a cut-out for loading and unloading conveyed articles.

Other conveyed articles containers are made like hanging flat trays made of plastic, which are covered on one side with elastic materials that clamp the conveyed articles.

It is known to mechanically load and manually unload such containers. A transport cycle is based on the slowest process, which also depends on the quantity of transported articles. In particular, a high number of individual conveyed articles can slow down loading and/or unloading. For example, unloading and/or assembling disassembled transport containers may determine the maximum possible transport cycle. EP 2 686 258 B1 relates to a hanging conveyor system with a transport bag for automatically unloading a loaded item and with an unloading station. The transport bag has a horizontal base on which the piece goods can be stored for transportation purposes. The bottom cooperates with a lifting device which is configured to lift the bottom of the transport bag loaded with at least one item when the transport bag is in an unloading position in a vertical direction in such a way that the at least one item can be pushed out centrally by means of a pushing device through one end face of a base body of the transport bag, wherein the pushing device has a pusher which engages through another end face of the base body into an interior of the base body, where the at least one item is located when the bottom is lifted. Unloading therefore requires the two opposing open end faces, the bottom that can be lifted in the vertical direction and the pusher of the pushing device that passes through one of the end faces. DE 20 2017 100 206 U1 discloses a conveyed articles container for a hanging conveyor system for transporting conveyed articles, which can be adjusted between an open position and a closed position. The conveyed articles container has a bottom that is mechanically associated with an ejection device. By means of the ejection device, the bottom can be adjusted between a transport position, in which the conveyed articles can be stored inside the conveyed articles container, and an ejection position, in which the conveyed articles can be ejected from the conveyed articles container.

DE 10 2018 105 795 A1 discloses a method for loading or unloading a conveyed material received on a limp material of a conveyed articles container by means of a station such as an unloading station and/or a loading station of a hanging conveyor system as well as a conveyed articles container, unloading station and hanging conveyor system according to the method. The conveyed articles container is brought closer to the station, where an attraction force is then exerted between the station and the conveyed articles container to couple the limp material of the conveyed articles container. The coupled conveyed articles container is tilted and the material is ejected from the conveyed articles container in a sliding movement.

DE 10 2018 128 417 A1 describes a method for transporting and sorting a sorter bag hanging from a roller adapter rolling on a rail network of a sorting system for transporting an item, with providing the rail network of the sorting system, providing the roll adapter of the sorter bag rolling on the rail network, providing an electrical drive energy for the roll adapter, converting the electrical drive energy provided by means of the roll adapter itself into kinetic energy for transporting the sorter bag, and devices according to the method. The roller adapters are used to hang and move the sorter bags. For this purpose, they each have a chassis with two coaxially rotating wheels, a suspension arranged between the wheels and supported by them, on which the sorter bag is hanging, an electric drive for driving the wheels and a control device or partial control device for autonomous or at least semi-autonomous control of the roll adapter along a travel path selected from a plurality of travel paths.

DE 10 2019 215 304 B3 discloses a device for feeding hanging articles into a hanging conveyor system. This comprises a feed unit for feeding the hanging conveyed articles singly into a conveyor system of the hanging conveyor system with a transport distance which can be defined in a variable manner, wherein the feed unit has a first stop element for stopping the hanging conveyed articles, and a detection unit for detecting the thickness of the individual hanging conveyed articles, a storage device for storing transport units comprising a plurality of transport units, a plurality of storage sections which are configured to store transport units, a feed section which is connected to the storage sections via a first switch in each case, a measuring device which is arranged on the feed section and is configured to store an extension of a transport unit in each case, and a control system which is connected to the measuring device and the first switches and is configured to select a storage section for storing the transport unit on the basis of the extent of the transport unit determined by the measuring device.

EP 3 972 917 B1 shows a hanging conveyor system comprising hanging bags, each of which comprises a bag body made of a flexible material which can be moved between a transport position and a loading position and is designed for transporting articles, a loading station which comprises an actuating device by means of which the bag body can be moved from the transport position to the loading position and from the loading position to the transport position, and at which a hanging bag can be loaded with articles when the bag body is in the loading position, a hanging conveyor device for transporting a hanging bag into the loading station and for transporting the hanging bag out of the loading station, with a measuring device which is configured to determine an extension of the bag body in a transport direction of the loaded hanging bag in the transport position of the bag body.

EP 3 800 146 B1 relates to a device for feeding hanging conveyed articles into a hanging conveyor system. This comprises a. a feed unit for feeding the hanging conveyed articles individually into a conveyor system of the hanging conveyor system with a transport distance that can be variably defined, wherein the feed unit has a separating element for separating the hanging conveyed articles, b. a detection unit for detecting the thickness of the individual hanging conveyed articles.

WO 2021/219361 A1 relates to a method for operating a transport device with a storage device and a corresponding transport device with a storage device. The method comprises the following steps: Providing the transport device with the storage device for storing transport units, comprising a plurality of transport units, a plurality of storage sections and a feed section to the storage sections. Furthermore, the transport device comprises an optical sensor arranged on the feed section and evaluation electronics connected to the optical sensor. The method further comprises obtaining measurement data with the optical sensor from a transport unit moving past the optical sensor and processing the measurement data obtained from the optical sensor with the evaluation electronics to determine the spatial extension in at least one dimension of the transport unit moving past; and selecting a storage path for storing the transport unit moving past on the basis of the obtained spatial extension of the transport unit moving past.

CH 715 506 A1 describes a storage device for storing transport units. This comprises a plurality of transport units, a plurality of storage sections which are configured to store transport units, a feed section which is connected to the storage sections via a first switch in each case, a measuring device which is arranged on the feed section and is configured to obtain an extension of a transport unit in each case, and a control system which is connected to the measuring device and the first switches and is configured to select a storage section for storing the transport unit on the basis of the extension of the transport unit obtained by the measuring device.

DE 102008035651 A1 relates to a shelf-like storage article carrier with a hanging receptacle arranged on the underside of the storage article carrier, on which storage articles can be hanging, wherein the storage article carrier can be moved in storage racks. The storage racks have at least two storage locations arranged one above the other in a vertical direction to accommodate the storage article carrier and a loading and/or removal station at which the at least one storage article carrier can be arranged so as to be accessible from outside the storage device. The storage article carrier can be moved along a transport route from a loading and/or unloading station to the storage locations using a conveyor device. Furthermore, a storage device of the aforementioned type with at least two storage columns and a method are disclosed, in which storage articles with several storage locations are automatically stored on top of one another, as a result of which a storage area for articles to be stored hanging can be utilized particularly efficiently.

It is also known to provide items such as storage articles or products with machine-readable codes that can be used to electronically detect the properties of the storage articles or products. DE 20 2012 008 937 U1 discloses a device for recognizing a code on an article or its packaging, preferably at the articles receipt of an order picking system, wherein the data of the code is read by machine with at least one optical reader and further processed, decoded and stored in an electronic data processing unit. The optical reader has a camera to which three light sources are assigned.

### SUMMARY OF DISCLOSURE

Based on this state of the art, the present disclosure is based on the object of improving storage processes in a hanging articles storage with a large number, in particular over a million, of autonomously or at least semi-autonomously movable article carriers in order to increase efficiency.

The object is solved with the method mentioned at the beginning by carrying out the following steps: providing at a transfer point of the hanging articles storage a storage article to be stored and providing a transport vehicle with an article carrier at the transfer point, loading the article carrier at the transfer point with the storage article, generating an article identifier identifying the storage article and/or a carrier identifier identifying the article carrier and/or a vehicle identifier identifying the transport vehicle and/or a length identifier identifying a length of the article carrier, wherein the length in a state of the article carrier loaded with the storage article depends on the storage article, and storing the storage article in the hanging articles storage by vertically transporting the transport vehicle including the article carrier loaded with the storage article from the transfer point to a level of the hanging articles storage, in which a defined or definable storage location for the storage article is located, and horizontal transportation of the transport vehicle including the article carrier loaded with the storage article in the respective level to the defined or definable storage location, wherein the storage location is defined or is being defined depending on the article identifier and/or vehicle identifier and/or carrier identifier and/or length identifier.

The method according to the disclosure enables a simple and very flexible storage of the storage articles at the desired storage locations in the hanging articles storage. The storage locations can, for example, be defined depending on one or more of the identifiers. This makes it possible, for example, to storage certain categories of storage articles by type in certain areas of the hanging articles storage by defining the storage locations of the storage articles of the respective category in the same area. In the same way, by knowing the vehicle identifiers, for example, similar transport vehicles can be stored in the same area, which is particularly advantageous for different vehicle types. It is also possible, for example, to make optimum use of the available space in the hanging articles storage by knowing the length of the loaded article carriers using the length identifiers. For example, the length of a storage line in the network or rail network may be known and the number of transport vehicles stored in the storage line may be determined in such a way that the sum of the lengths of the article carriers is as close as possible to the length of the storage line. This means that the article carriers can be stored in a space-optimized way, either in line with each other or without any significant distance to an adjacent article carrier, and the corresponding storage can be planned in advance. By knowing the carrier identifiers, for example, similar product carriers can be stored in a desired area.

In the context of this application, an identifier is to be understood as any characteristic date, in particular a sequential number or a number in words. In the case of a number in words, for example, this can contain information on a storage location and/or properties of the storage article. The identifier can therefore also be understood as a multitude of summarized individual data.

It is of course advantageous to generate not only the article identifier at the transfer point, but also one or more identifiers at the same time, i.e. carrier identifiers and/or vehicle identifiers and/or length identifiers. These multiple identifiers can be processed together, in particular combined into a data array. There is then advantageously a summarized information, e.g. about the length of the article carrier on the one hand and the storage article contained therein and an identification of the article carrier and/or the transport vehicle itself. Information about the length of the article carrier can be used to calculate storage requirements, for example. Autonomous or at least semi-autonomous driving of the transport vehicles in the network or rail networks means that they can be stored in a space-saving manner according to the individual length of the article carriers, which can depend on the storage articles. This length means that storage locations with an individual length can be allocated so that a space requirement can be calculated before the autonomous or at least semi-autonomous transport vehicles, including the loaded article carrier, actually arrive at their storage location.

It is therefore possible to calculate how much storage space will be required by the article carrier that has just been entered into the data system and loaded with the storage article at the transfer point. The length of an article carrier can be generated by calculation based on knowledge of the dimensions of the storage article or by measurement. In the case of a measurement, a random position of the storage articles within the material can be taken into account. In the case of a forecast, a maximum value can be assumed. The article carriers can be loaded quickly and stored in a storage location with minimal space requirements. Compared to fixed storage locations within the hanging articles storage, this results in a smaller space requirement. The method can be carried out at one or in parallel at a large number of transfer points and/or repeatedly for a plurality of article carriers.

In a preferred exemplary embodiment, the following steps are also carried out: taking out the storage article from the hanging articles storage by horizontal transportation of the transport vehicle including the article carrier loaded with the storage article from the defined storage location in the respective level of the hanging bag storage, vertical transportation of the respective transport vehicle including the article carrier loaded with the storage article from the respective level into an unloading station of the hanging bag storage and unloading of the storage article from the article carrier in the unloading station. This allows one or more of the desired storage articles to be taken out quickly and easily.

Preferably, the article identifier and/or bag identifier and/or vehicle identifier and/or length identifier is transmitted to a central control device of the hanging articles storage, the storage location is determined by means of the central control device depending on the received article identifier and/or carrier identifier and/or vehicle identifier and/or length identifier and the storage article are stored in the defined storage location by controlling the vertical transport and the horizontal transport by means of the central control device. This allows the identifiers to be recorded on site at the transfer point and processed centrally by the control device. All important information for process monitoring is available in the control device. This means that storing can be carried out largely in an automated way.

According to an advantageous embodiment of the method, the following steps are carried out: detecting a machine-readable article code of the storage article and/or a machine-readable carrier code of the article carrier and/or a machine-readable vehicle code of the transport vehicle and/or the length of the article carrier at the transfer point by means of a detection device, preferably optically or by means of near-field communication, generating the article identifier from the detected article code and/or the carrier identifier from the detected carrier code and/or the vehicle identifier from the detected vehicle code and/or the length identifier from the detected length by means of a computing unit downstream of the detection device and transferring the generated article identifier and/or carrier identifier and/or vehicle identifier and/or length identifier to the central control device.

The codes can be any machine-readable code, for example an optically readable code such as a barcode or QR code. Preferably, the codes are so-called SMART codes, which usually have a square shape with square pixels and three characteristic additional squares arranged in three of the four corners. It is conceivable that the codes from an optically captured image are found using characteristics such as the three squares and then the code is read from an image area found in this way. The identifiers can be generated easily and automatically by optical capturing. In the context of the present application, however, a machine-readable code is also to be understood as a contactless readable code that can be read by near-field communication. The code may be provided, for example, in the form of a passive transponder on the storage article, article carrier or transport vehicle. Reading may be carried out using a suitable reading unit. Standardized communication technologies such as RFID (radio-frequency identification) or NFC (near field communication) could only be used as examples.

It is conceivable that several codes can be detected using a single detection device. However, several separate detection devices could also be used, e.g. one detection device for each specific code. In the case of several optical detection devices, these may be configured as identical parts, in particular each with its own computing unit. When optically detecting the length of the article carrier, the article carrier can be recorded as a whole or in sections and, for example, also from a certain angle, such as from the side. The length can be deduced from the image data obtained in this way. This may be done, for example, using suitable evaluation software that may be implemented in the computer unit.

According to a further advantageous embodiment of the method, the following steps are carried out: storing a plurality of storage articles in a respective defined storage location according to the steps of claim 1, and taking out the plurality of storage articles according to the steps of claim 2, wherein the transport vehicles including the loaded article carriers are sorted during taking out and fed to the unloading station in a defined sequence, wherein the sequence is preferably defined by the central control device as a function of the article identifier and/or carrier identifier and/or vehicle identifier and/or length identifier. This makes it easy to arrange storage articles in a desired sequence during the process of taking out, e.g. for a specific packaging. As sorting takes place during the process of taking out, time can be saved compared to conventional methods.

According to a further advantageous embodiment of the method, the following steps are carried out: autonomously driving and propelling the transport vehicles, at least for horizontal transportation along the network, in particular the rail network, in a time period between receiving a first control signal from the central control device and receiving a subsequent second control signal from the central control device. This reduces the control effort, as the transport vehicles mainly move independently in the network, especially the rail network, and only receive control signals from the central control device at irregular intervals.

The method is preferably carried out in a hanging bag storage, where a hanging bag is used as the article carrier, a bag identifier is used as the carrier identifier and a bag code is preferably used as the carrier code. The method has proven to be particularly advantageous for hanging bag storages. The hanging bags may have a limp and/or foldable material in which the storage articles can be stored. This adapts to the corresponding storage article, wherein the length of the hanging bag is influenced. Of course, other forms of hanging articles storages would also be conceivable, i.e. other types of article carriers, for example garment holders that can be hanging from the transport vehicle to hold an item of clothing or holding devices for containers such as packages, liquid containers, etc. Regardless of the specific embodiment of the hanging articles storage, the basic system of the method remains the same.

The object is further solved by a hanging articles storage for carrying out the method described above. This results in the advantages described above.

Finally, the object is solved with the above-mentioned hanging articles storage in that a transfer point is provided for transferring a storage article to be stored in the hanging articles storage to an article carrier attached to a transport vehicle, that means for generating an article identifier identifying the storage article and/or means for generating a carrier identifier identifying the article carrier and/or means for generating a vehicle identifier identifying the transport vehicle and/or means for generating a length identifier identifying a length of the article carrier are provided, wherein the length of the article carrier in a state loaded with the storage article depends on the storage article, that a first means is provided for vertically transporting the transport vehicle including the article carrier loaded with the storage article from the transfer point to a level of the hanging bag storage in which a fixed or fixable storage location for the storage articles is located, and that a central control device is provided which is configured to control the first means for vertically transporting the article carrier and the respective transport vehicle in such a way that the storage article can be stored in the defined or definable storage location, wherein the storage location is defined or definable depending on the article identifier and/or carrier identifier and/or vehicle identifier and/or length identifier. The advantages are the same as described above for the method. This also applies to the following dependent claims.

According to an advantageous embodiment, the hanging articles storage comprises an unloading station for unloading a stored article to be taken out from the article carrier and a second means for vertically transporting the transport vehicle including the article carrier loaded with the storage article to be taken out from the level of the hanging articles storage in which the defined or definable storage location is located to the unloading station, wherein the central control device is configured to control the second means for vertically transporting the article carrier and the transport vehicle of the article carrier loaded with the storage article in such a way that the transport vehicle, including the article carrier loaded with the storage article, can be fed from the defined or definable storage location to the unloading station.

According to a further advantageous embodiment of the hanging articles storage, it is provided that a plurality of storage articles, each received on an article carrier, can be stored by means of a plurality of transport vehicles at defined storage locations in a level or in different levels, and can be taken out from the storage locations and fed sequentially to the unloading station, wherein the central control device is configured to control the second means for vertically transporting the article carrier and the plurality of transport vehicles in such a way that the plurality of transport vehicles, including the loaded article carriers, are sorted during the taking out and can be fed to the unloading station in a defined order, wherein the order is preferably defined or definable depending on the article identifier and/or carrier identifier and/or vehicle identifier and/or length identifier.

An exemplary embodiment of the hanging bag storage is characterized in that the means for generating the article identifier and/or the means for generating the carrier identifier and/or the means for generating the vehicle identifier and/or the means for generating the length identifier comprises at least one detection device upstream of a computing unit, for detecting a machine-readable article code of the storage article and/or a machine-readable carrier code of the article carrier and/or a machine-readable vehicle code of the transport vehicle and/or the length of the article carrier, wherein the computing unit is connected data-technically to the central control device.

In a preferred alternative, the at least one computing unit may have its own IP address, via which the data-technical connection with the central control device can be established. The IP address can be used to access standards for transferring the identifiers. In addition, the at least one computing unit may be maintained, monitored and controlled by the central control device wirelessly or by cable.

According to a preferred embodiment, the detection device comprises at least one camera for optically detecting an optically readable article code and/or an optically readable carrier code and/or an optically readable vehicle code and/or the length, wherein preferably one camera each is provided for detecting one of the codes and each camera and a separate computing unit with a separate IP address is provided downstream of each camera. The optically readable code is preferably a barcode or QR code or SMART code in general. Alternatively or additionally, the detection device may comprise at least one reading unit for contactless reading of a contactless readable article code and/or a contactless readable carrier code and/or a contactless readable vehicle code, preferably based on near-field communication, in particular NFC or RFID. The detection device may be a digital camera chip that is connected directly to a programmable computing device or a computer on a common circuit board, for example. Such units consisting of a camera and a computer may advantageously be configured as identical parts, for example for each identifier to be generated, in particular only with different programming. However, it is also conceivable that several optical detection devices are connected upstream of a common computing unit. The computing unit may be a small computer that can be procured, connected and programmed on an industrial scale at low cost. The image processing required to generate the identifiers may be carried out on site, e.g. using suitable software implemented in the respective computing unit. The result of this can be used as required, for example centrally, without incurring computing costs at a central location. This may also save data traffic for transferring raw data, especially image data.

If, for example, several cameras are provided, several identifiers can be obtained separately from each other, wherein a central control and coordination of the data determination carried out directly at the transfer point can be carried out via the separate IP addresses by means of the central control device despite the separate configuration. For example, the article identifier, the carrier identifier and the length identifier can be checked for plausibility, e.g. whether any known dimensions of the storage article with the determined length identifier result in a plausible value for the length of the article carrier. An on-site detection enables very fast processing; for example a detection process can be carried out in less than 50 ms, in particular less than 30 ms, preferably in around 30 ms. The separate computing units can be programmed simply and easily, for example using memory cards. They may be simple in design, as they only have to fulfil one task. Simple replacement is possible for maintenance. If necessary, only the IP address must be reassigned or taken into account. They can also be used separately at different locations, although the overall task of recording incoming articles is still possible. The application may also be scaled to several transfer stations. Once the incoming articles have been recorded, the hanging bags can be directed to the storage location using the central control device.

Advantageously, the transport vehicles are configured to be moved and driven autonomously, at least for horizontal transport along the network, in particular the rail network, in a period between the receipt of a first control signal from the central control device and the receipt of a subsequent second control signal from the central control device.

Furthermore, it may be advantageous if the plurality of transport vehicles comprises at least two different vehicle types, wherein the vehicle types preferably differ in at least one of the following parameters: drive power, load capacity, fastening device for the article carrier, length in the direction of movement, height in the vertical direction. This means, for example, that a more powerful transport vehicle can be used for heavy articles than for lighter articles. In the same way, a correspondingly larger transport vehicle could be used for larger transport articles than for smaller transport articles, etc.

It is advantageous if the hanging articles storage has means for automated loading of an article carrier with a storage article at the transfer point, preferably comprising a stationary or mobile first handling robot, and/or means for automated unloading of a storage article from an article carrier in the unloading station, preferably comprising a stationary or mobile second handling robot. This means that loading and unloading can be carried out in an automated way. The handling robots may be controlled via the central control device, for example.

According to a further advantageous embodiment, the first means for vertically transporting the product carriers comprises a first vertical conveyor and/or the second means for vertically transporting the product carriers comprises a second vertical conveyor, wherein the first vertical conveyor and/or the second vertical conveyor preferably are configured as a ring conveyor system, in particular as a continuously conveying ring conveyor system. A continuously conveying ring conveyor system is, for example, a well-known “paternoster”. Vertical transportation may be continuous or intermittent. Intermittent may mean that the carrier units of the ring conveyor system, which are configured to accommodate one or more transport vehicles, are each stopped for a certain period of time at one level of the hanging articles storage so that a number of transport vehicles can drive from the network, in particular the rail network, onto the carrier unit. The carrier unit can then be moved to the next level and stop there again for a certain period of time so that a number of transport vehicles can move from the carrier unit to the network, in particular the rail network, of the respective level. The ring conveyor system may be controlled by the central control device. The central control device may be configured to coordinate the movement of the ring conveyor system and the movement of the transport vehicles, for example for the advantageous sorting described above to produce a fixed order of storage articles.

According to a preferred embodiment, the hanging articles storage is configured as a hanging bag storage, wherein the article carrier comprises a hanging bag, wherein the carrier identifier is a bag identifier and the carrier code is preferably a bag code. However, as already explained, other embodiments are also conceivable. A mixed operation with different article carriers would also be conceivable.

According to a further advantageous embodiment of the hanging articles storage, a first level of the hanging articles storage or a first area of a level can be assigned or assignable a number of defined or definable first article identifiers and/or first carrier identifiers and/or first vehicle identifiers and/or first length identifiers, and a second level or a second area of the level can be assigned or assignable a number of defined or definable second article identifiers and/or second carrier identifiers and/or second vehicle identifiers and/or second length identifiers. The central control device may be configured to define the storage locations for storage articles with first article identifiers and/or first carrier identifiers and/or first vehicle identifiers and/or first length identifiers in the first level or in the first area of the respective level, and to define the storage locations for storage articles with second article identifiers and/or second carrier identifiers and/or second vehicle identifiers and/or second length identifiers in the second level or in the second area of the respective level. This means, for example, that storage articles of a certain category or hanging carrier of a certain length or type can be stored in a level or area of a level provided for this purpose. For example, there could be levels with different heights and article carriers with a matching height could be stored on each level. This allows the available space to be utilized in the best possible way.

Further advantages result from the subclaims and the following description of a preferred exemplary embodiment.

### BRIEF DESCRIPTION OF THE FIGURES

The disclosure is explained in more detail below with reference to an exemplary embodiment shown in the figures. These show:

FIG. 1 is a schematic three-dimensional view obliquely from the top front laterally of a hanging articles storage in the form of a hanging bag storage;

FIG. 2 is a schematic side view of a hanging bag for the hanging bag storage shown in FIG. 1;

FIG. 3 is a schematic side view of several of the hanging bags on a rail network shown in FIG. 2;

FIG. 4 is a 3-dimensional view obliquely from the top laterally of a transfer point for transferring storage articles into the hanging bag storage; and

FIG. 5 is: a flow chart of a method for controlling and operating the hanging bag storage shown in the previous figures.

### DESCRIPTION OF THE PREFERRED EMBODIMENTS

Before describing the disclosure in detail, it should be pointed out that it is not limited to the respective components of the device and the respective method steps, as these components and methods may vary. The terms used here are only intended to describe particular embodiments and are not used in a restrictive manner. Furthermore, if the singular or indefinite articles are used in the description or in the claims, this also refers to the plurality of these elements, unless the overall context clearly indicates otherwise.

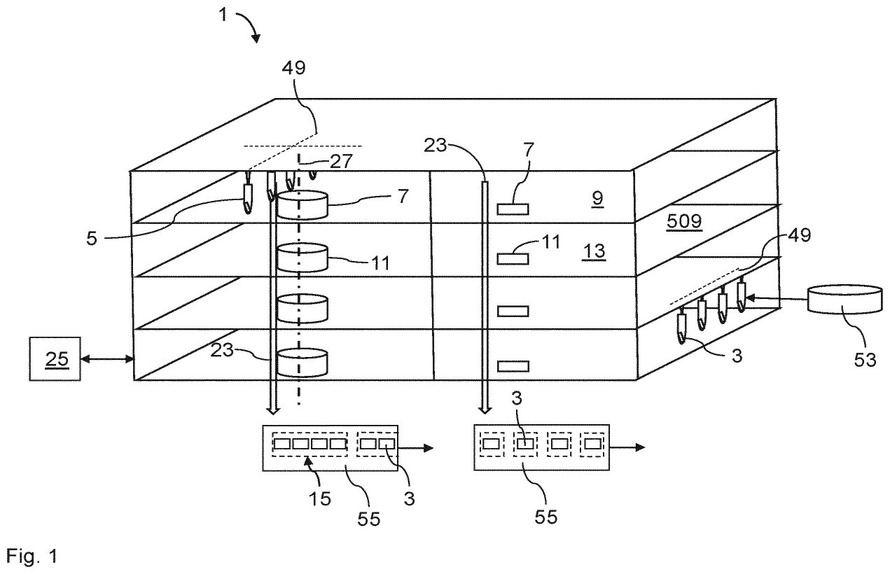

FIG. 1 shows a schematic three-dimensional view obliquely from the top front laterally of a hanging bag storage 1. The hanging bag storage shown is merely a preferred, but not restrictive, embodiment of the hanging articles storage 1 according to the disclosure.

The hanging bag storage 1 has at least two levels 9, 13, in this case a total of four, wherein a first level 9 and a second level 13 are provided with reference signs by way of example. More or fewer levels are conceivable, for example 10 levels or more, which are arranged vertically one above the other. Each of the levels 9, 13 of the hanging bag storage 1 may have a transfer buffer 7, 11, of which only a first transfer buffer 7 and a second transfer buffer 11 are also provided with reference signs.

The hanging bag storage 1 shown is used for picking up, storing, sorting and/or taking out storage articles 3. Optionally, the hanging bag storage 1 may be configured as a pure storage or pure sorting device. The transfer buffers 7, 11 are preferably arranged vertically one above the other, which is symbolized by a line 27. However, it is also conceivable to arrange only at least two of the transfer buffers 7, 11 one above the other and/or to arrange them at an angle to a vertical spatial direction along the line 27.

Along the imaginary line 27, along which the transfer buffers 7, 11 are preferably also arranged, there also runs a vertical conveyor of any configuration for vertically conveying the loaded or unloaded hanging bags 5 between the levels 9, 13 and from a transfer point (loading point) 53 to the levels 9, 13 and in the opposite direction back to an unloading station 55, preferably a plurality of such conveyors. In the embodiment shown, a vertical conveyor is provided merely as an example, which is configured both for vertical conveying of the storage articles 3 to be stored and for vertical conveying of the storage articles 3 to be taken out, in particular for transporting the transport vehicles 61 described in more detail below.

However, it is advantageous if a first vertical conveyor is provided for vertically transporting the transport vehicles 61 from the transfer point 53 to the levels 9, 13 and a second vertical conveyor is provided for vertically transporting the transport vehicles 61 from the levels 9, 13 to the unloading station 55. The available vertical conveyors may be configured in particular as a ring conveyor system 23, especially a continuous conveying ring conveyor system, e.g. as a known paternoster.

The transfer buffers 7, 11 are optionally and preferably arranged adjacent to the ring conveyor system 23 in such a way that the storage articles 3 can be transferred from these to the ring conveyor system 23 and/or can be stored by the latter in the levels 9, 13 or the transfer buffers 7, 11 of the levels 9, 13.

A network 49, in particular a rail network 49, is provided in each level 9, 13. The rail network 49 may have connecting sections and branches such as crossings and/or switches. It is preferably a grid with straight rails connected to each other by crossings and/or switches. For example, with rectangular network meshes.

Furthermore, a plurality of self-propelled transport vehicles 61 is provided, for example several hundred to several thousand transport vehicles 61. The transport vehicles 61 can be hooked into the rail network 49 and move autonomously and independently of one another along the rail network 49. In particular, the drive is therefore without a drag chain. For example, the hanging bag storage 1 is constructed without drag chains at least in some areas or completely, preferably at least within the levels 9, 13. An article carrier 5 for receiving a storage article 3 is attached to each transport vehicle 61, preferably detachably or interchangeably. In the example of the hanging bag storage 1 shown, the article carrier 5 is configured as a hanging bag. In particular, the hanging bags 5 have a limp and/or foldable material in which a stored item 3 can be stored.

Particularly preferably, the transport vehicles 61 are configured in such a way that they travel autonomously on the network, in particular the rail network 49. Hanging bag storages 1 with transport vehicles 61 moving autonomously in a rail network are known and are described, for example, in DE10 2018 128 417 A1.

Furthermore, hanging bag storages with transport vehicles 61 which move autonomously in a network, in particular a transport network, and which are formed by transport carriers which can be moved while adhering to a running surface, are described in WO 2023/147620 A1 and this embodiment is hereby made the subject of the present disclosure. In particular, the transport carrier and the transport network are made the subject of this disclosure. The transport vehicles 61 of the present application may therefore be configured in the same way as the transport carriers of WO 2023/147620 A1 and the network 49 of the present application may be configured in the same way as the transport network of WO 2023/147620 A1.

Said transportation network may include transport paths and path markings may be provided along the transport paths of the transport network. Preferably, the path markings are arranged on a supporting structure, in particular on the driving surface. The transport carrier may be guided along the transport path. The path marking may comprise travel markings that are preferably followed by the transport carrier as it moves. The (in particular optical or magnetic) travel marking may thus be configured as a guiding or travel line on or in the travel surface of the support structure along which the transport carrier is to travel (line-guided transport vehicle). For this purpose, it is particularly advantageous if the travel mark is detected by the transport carrier, in particular by a detection unit of the transport carrier, and the transport carrier is controlled by a travel control system in such a way that the transport carrier is moved along the travel mark. Preferably, the travel marking is configured as a travel line running along the transport path with a first edge and a second edge.

A central control device 25 is also provided for monitoring and controlling the hanging bag storage 1. The control device 25 may preferably communicate with the transport vehicles 61, in particular to send control commands to the transport vehicles 61 and, if necessary, to receive signals from the transport vehicles 61. Furthermore, the control device 25 may exchange information with other functional units of the hanging bag storage 1, for example to control the available vertical conveyors, in particular ring conveyor systems 23.

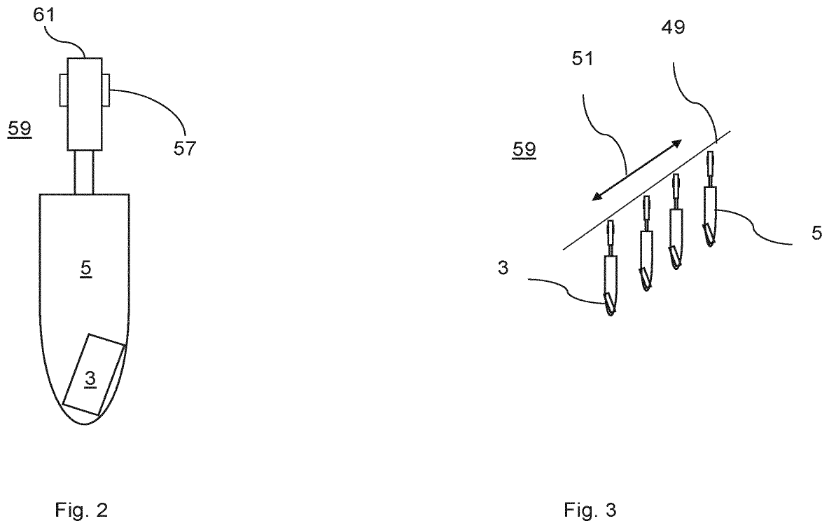

FIG. 2 shows a schematic side view of a transport vehicle 61 with a hanging bag 5 for the hanging bag storage 1 shown in FIG. 1. FIG. 3 shows a schematic side view of several of the transport vehicles 61 shown in FIG. 2 with hanging bags 5, hanging in the rail network 49. The transport vehicles 61 have wheels 57 and can be driven by means of a drive energy merely indicated by the reference sign 59 and a drive using this energy. The drive may be provided by a suitable electric motor, for example.

In FIG. 3, a double arrow 51 indicates a possible direction of movement of the transport vehicles 61 including hanging bags 5 in the network 49, in particular the rail network 49. In particular, the transport vehicles 61 are configured, programmed and/or designed for autonomous or semi-autonomous driving on the network 49, in particular rail network 49. In addition to the drive, these may have their own control device for controlling the longitudinal and lateral dynamics control. Furthermore, the transport vehicles 61 preferably comprise a suitable communication device (not shown) for communicating with the central control device 25 of the hanging bag storage 1, which is described in more detail below. The communication device may, for example, have a wireless receiver unit to receive control signals from the control device 25.

FIG. 2 shows the hanging bag 5 with the storage article 3 received therein. The storage article 3 is located inside a U-shaped hanging material, in particular a limp material. Loading and unloading may be carried out from above or from the side.

Preferably, the transport vehicles 61 including the storage articles 3 in the hanging bag 5 are transferred to the respective vertical conveyor, e.g. to the ring conveyor system 23. Particularly preferably, the respective transport vehicle 61 including the hanging bag 5 attached thereto is driven, controlled and/or moved autonomously before and during providing at the transfer point 53 and during transfer of the transport vehicle 61 to the hanging bag storage 1.

To store the storage articles 3 in the hanging bag storage 1, the hanging bag storage 1 is provided with the transfer point 53. At the transfer point 53, individual hanging bags 5 can be loaded with storage articles 3. Each hanging bag 5 is attached to a transport vehicle 61 and can therefore be transferred to the hanging bag storage 1 after loading by moving the transport vehicle 61. Preferably, each hanging bag 5 is loaded with only one storage article 3. However, several are also conceivable, provided they can be accommodated in the corresponding hanging bag 5. At the transfer point 53, the storage articles 3 may optionally be buffered and transferred directly to the hanging bags 5, which move to the transfer point 53 and then continue autonomously to a storage location 509 of the hanging bag storage 1.

At the unloading station 55 of the hanging bag storage 1, the storage articles 3 can be unloaded from the hanging bags 5 and are available there, preferably in a predetermined or predeterminable order 15. For this purpose, the transport vehicles 61, in particular rail-guided or line-guided, can first be moved from a storage location 509 in one of the levels 9, 13 to the vertical conveyor, in particular the ring conveyor system 23, which is done in particular autonomously or semi-autonomously. One or more of the transport vehicles 61 including the loaded hanging bags 5 can then be fed from the respective level 9, 13 to the unloading station 55 by means of the vertical conveyor. To produce the desired order of storage articles 3, the control unit 25 may control the corresponding transport vehicles 61 on the one hand and the vertical conveyor for the unloading station 55 on the other hand. The control device 25 may coordinate the movements of the transport vehicles 61 and the movement of the vertical conveyor in order to obtain the desired order.

It is conceivable that a queue of hanging bags 5 could move in the desired order 15 from the vertical conveyor, in particular the ring conveyor system 23, into the unloading station 55 or be transferred from the ring conveyor system 23 to the unloading station 55, unloaded there and then returned for further loading. The unloading station 55 may be arranged inside or outside one of the levels 9, 13, preferably in a lowest level. Alternatively, however, it is also conceivable that the hanging bags 5 are conveyed by means of the vertical conveyor, in particular the ring conveyor system 23, and unloaded at the unloading station 55 in the desired order and immediately transported back empty into the hanging bag storage 1, i.e. without the respective hanging bags 5 being directly available there, for example in order to be transported on to the transfer point 53 after unloading.

The hanging bags in the unloading station 55 may be unloaded manually by an operator. Alternatively, however, it is also conceivable to carry out the unloading of the hanging bags 5 mechanized or by means of a handling robot (not shown), wherein the handling robot may comprise a stationary or mobile handling robot. The handling robot can preferably be controlled by the central control device 25.

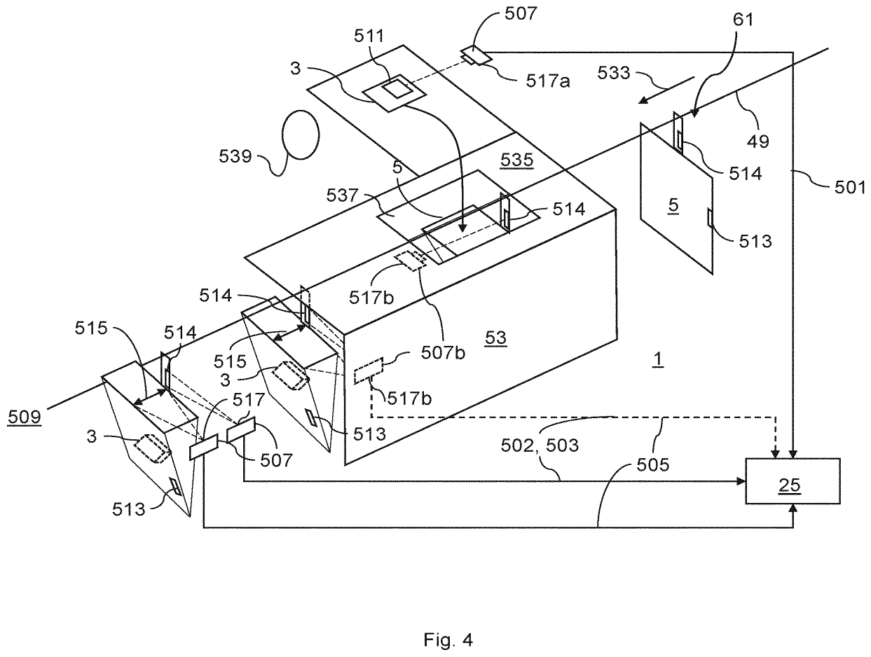

FIG. 4 shows a 3-dimensional view obliquely from the top laterally of a transfer point 53 for transferring storage articles 3 into the hanging bag storage 1. A part of the network 49, in particular a rail network 49, can be seen, which acts as an infeed for the transfer point 53 at this point. A feed direction of the hanging bags 5 is symbolized in FIG. 4 by an arrow 533. Via the network 49, in particular rail network 49, the rail-guided or line-guided transport vehicles 61 with hanging bags 5 hanging therefrom can travel under a loading table 535, which has a loading opening 537 for loading the hanging bags 5 from above.

The storage articles 3 can be inserted into the hanging bags 5 from above through the loading opening 537. This process may be carried out by an operator 539. Alternatively, however, it is also conceivable to carry out the loading of the hanging bags 5 mechanized or by means of a handling robot (not shown), wherein the handling robot may comprise a stationary or mobile first handling robot. It is also conceivable to load the hanging bags 5 from the side.

In the exemplary embodiment shown here, the operator 539 starts the loading process by manually gripping one of the storage articles 3 provided and feeding it to a detection device 517. The operator 539 receives the storage article 3 in a known manner, for example via a mechanized infeed such as a conveyor belt, load carrier, shelf or similar.

To record the properties of the storage article 3, it has an article code 511, for example. The article code 511 may be an optically readable machine-readable code, e.g. a standard barcode in the case of consumer articles. However, it is also conceivable that the article code 511 has any other optically readable code, for example a square smart code such as a QR code. As a rule, the operator 539 already receives the storage article 3 provided with the article code 511. However, if the storage article 3 does not have an article code 511, this may also be affixed to the storage article 3 by the operator 539, e.g. in the form of a sticker or similar. Alternatively, the machine-readable article code may also be in the form of a contactless readable RFID or NFC transponder mentioned at the beginning.

After starting the loading process, one or more identifiers can be generated, e.g. an article identifier 501 and/or a bag identifier 503 (generally a carrier identifier) and/or a vehicle identifier 502 and/or a length identifier 505. For this purpose, the detection device 517 may have means for optical (in the case of optically readable codes) detection or means for contactless detection (in the case of near-field communication) and an associated computing unit 507 for performing calculations. In the exemplary embodiment shown, the detection device 517 comprises a first camera 517a and, connected downstream, a first computing unit 507a for optically detecting the article code 511 and generating the article identifier 501, a second camera 517b and, connected downstream, a second computing unit 507b for detecting the bag code 513 and generating the bag identifier 503 and a third camera 517c and, connected downstream, a third computing unit 507c for optically detecting and measuring the length 515 of the hanging bag 5 and generating the length identifier 505. The second camera 517b and the second computing unit 507b may also be configured to capture the vehicle code 514 and generate the vehicle identifier 502. The generated identifiers 501, 502, 503 and 505 may be transmitted to the central control device 25 via a link, in particular a radio link and/or cable link.

Alternatively, however, several codes and/or one or more codes and the length 515 of the hanging bag 5 could also be detected by a common detection unit 517, for example by a camera. A corresponding result transfer of the obtained identifiers, here exemplarily bag identifier 503 and length identifier 505, to the central control device 25 is shown in dashed lines in FIG. 4.

For data transfer, the detection device 517 may have one or more IP-addresses, preferably a separate IP-address for each separate computer.

Once the identifiers 501, 502, 503 and 505 have been transferred, the control device 25 may assign the hanging bag 5 or the storage article 3 contained therein to a storage location, indicated in the figure only by the reference sign 509, which the transport vehicle 61 of the respective hanging bag 5 then controls autonomously or at least semi-autonomously heads for.

After loading, the hanging bag 5 has an individual length 515 depending on the position within the hanging bag 5 and the properties of the storage article 3, which is symbolized by a double arrow in FIG. 4. Depending on the length 515, more or less space is required in the storage location 509. By measuring the hanging bag 5, or more precisely by generating the length identifier 505, it is possible to measure and plan the storage space 509 individually for each hanging bag 5. This means that the storage space available in the hanging bag storage 1 can be optimally utilized.

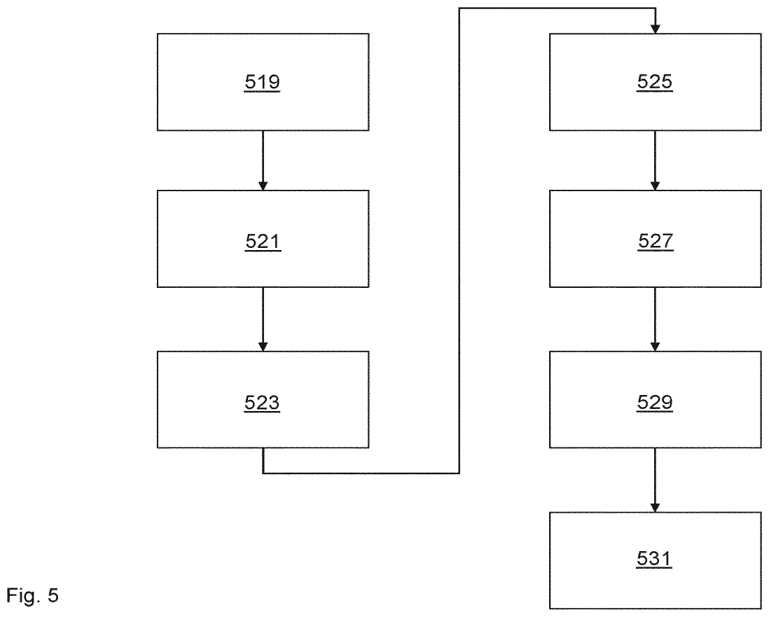

FIG. 5 shows a flow chart of a method for controlling and operating the hanging bag storage 1 shown in the previous figures. Reference is also made to the previous figures.

In a first step 519, the storage article 3 to be stored is provided at the transfer point 53. The storage article preferably has an article code 511. If the storage article does not have an article code 511, the operator may also provide an article code 511 on the storage article, for example by affixing a sticker containing the article code. The transfer point 53 may be provided on one level, in particular on or at the lowest level, of the hanging bag storage 1 and may be loaded mechanically or manually by means of the operator 539. In a further step 521, a transport vehicle 61 with a hanging bag 5 attached thereto is provided at the transfer point 53. This may be done, for example, by the transport vehicle 61 receiving a corresponding control command from the central control device 25. The transport vehicle 61 can then travel essentially autonomously along a rail of the rail network 49 to the transfer point 53, as indicated by the arrow in FIG. 3. The step 521 may of course also be performed before or parallel to the step 519.

The operator can grasp the storage article 3 provided in order to generate an article identifier 501 in a further step 523, which identifier uniquely identifies the storage article 3. This may be done, for example, by reading the article code 511 by means of the detection device 517, e.g. optically or by near-field communication. The article identifier 501 may be generated from the article code 511, preferably by the computing unit 507 downstream of the detection device 517. In a further step 525, the storage article 3 is fed, for example through the loading opening 537, to the hanging bag 5 waiting at the loading table 535, i.e. the hanging bag 5 is filled or loaded with the storage article 23.

In a further step 527, for example, a bag identifier 503 can be generated, which uniquely identifies the hanging bag 5. This may be done, for example, by reading a bag code 513 provided on the respective hanging bag 5 or attachable thereto by the operator by means of the detection device 517, for example optically (see FIG. 3) or by near-field communication, and the computing unit 507 generating the bag identifier from this. In an analogous manner, a vehicle identifier 502 could alternatively or additionally also be generated in a step 529, for example by reading a vehicle code 514 provided on the respective transport vehicle 61 or attachable thereto by an operator by means of the detection device 517, for example again optically (see FIG. 3) or by near-field communication, and the computing unit 507 generating the vehicle identifier 502 from this.

After loading with the storage article 3, the hanging bag 5 has an individual length 515 depending on the storage article. In a further step 531, a length identifier 505 may advantageously be generated, which identifies the length 515 of the hanging bag (in the direction of movement). This may be done, for example, by measuring the loaded hanging bag 5, in particular optically. The measuring may be carried out by means of a suitable camera of the detection device 517 and a downstream computing unit 507. For example, a suitable image processing software may be implemented in the computing unit 507 for this purpose, which can obtain the length 515 from the image data recorded by the camera. The obtained identifiers 501, 502, 503, 505 are transferred from the respective computing unit 507 to the central control device 25, for example via a suitable wireless or wired data communication.

The storage article 3 to be stored is preferably paired with the hanging bag 5 provided and/or with the transport vehicle 61 to which the hanging bag 5 is attached and/or with the length 515 of the hanging bag by data-technically linking the available identifiers with one another. As a result, the central control device 25 not only has information about the storage article 3, but in particular also further information about the hanging bag in which the respective storage article 3 is located and/or the transport vehicle 61 with which the storage article 3 is transported, as well as information about the length 515 of the filled hanging bag 5. In addition to the pairing process of the stored item 3 with the hanging bag 5, information about the individual length 515 of the hanging bag 5 is also available in the form of the length identifier 505.

List of reference signs

| | |
|---|---|
| 1 | hanging articles storage |
| | hanging bag storage |
| 3 | storage article |
| 5 | article carrier, hanging bag |
| 7 | first transfer buffer |
| 9 | first level |
| 11 | second transfer buffer |
| 13 | second level |
| 15 | order |
| 23 | ring conveyor system |
| 25 | central control device |
| 27 | line |
| 49 | network, rail network |
| 51 | double arrow |
| 53 | transfer point |
| 55 | unloading station |
| 57 | wheels |
| 59 | drive energy |
| 61 | roller adapter |
| 501 | article identifier |
| 502 | vehicle identifier |
| 503 | bag identifier |
| 505 | length identifier |
| 507 | computing unit |
| 509 | storage location |
| 511 | article code |
| 513 | bag code |
| 514 | vehicle code |
| 515 | length |
| 517 | detection device |
| 519 to 531 | method steps |
| 533 | arrow |
| 535 | loading table |
| 537 | loading opening |
| 539 | operator |

1. A method for controlling a hanging articles storage for storage articles to be stored hanging, wherein the hanging articles storage comprises a number of levels, in each of which a network, in particular a rail network, is provided, and a plurality of self-propelled transport vehicles, each having an article carrier attached or attachable hanging thereto for receiving a storage article, which transport vehicles can be moved independently of one another along the network, characterized by:
providing at a transfer point of the hanging articles storage a storage article to be stored and providing a transport vehicle with an article carrier at the transfer point,
loading the article carrier at the transfer point with the storage article,
generating an article identifier identifying the storage article and/or a carrier identifier identifying the article carrier and/or a vehicle identifier identifying the transport vehicle and/or a length identifier identifying a length of the article carrier, wherein the length in a state of the article carrier loaded with the storage article, depends on the storage article,
storing the storage article in the hanging articles storage by vertical transportation of the transport vehicle including the article carrier loaded with the storage article from the transfer point to a level of the hanging articles storage in which there is a defined or definable storage location for the storage article, and horizontal transportation of the transport vehicle including the article carrier loaded with the storage article in the respective level to the defined or definable storage location, wherein the storage location is defined or is being defined depending on the article identifier and/or vehicle identifier and/or carrier identifier and/or length identifier.

2. The method according to claim 1, characterized by:
taking out the storage article from the hanging articles storage by horizontal transportation of the transport vehicle including the article carrier loaded with the storage article from the defined storage location in the respective level of the hanging articles storage,
vertical transportation of the respective transport vehicle including the article carrier loaded with the storage article from the respective level into an unloading station of the hanging articles storage and
unloading the storage article from the article carrier in the unloading station.

3. The method according to claim 1, characterized by:
transmitting the article identifier and/or the carrier identifier and/or the length identifier to a central control device of the hanging articles storage,
determining the storage location by means of the central control device depending on the received article identifier and/or carrier identifier and/or vehicle identifier and/or length identifier, and
storing the storage article at the defined storage location by controlling the vertical transport and the horizontal transport by means of the central control device.

4. The method according to claim 1, characterized by:
detecting a machine-readable article code of the storage article and/or a machine-readable carrier code of the article carrier and/or a machine-readable vehicle code of the transport vehicle and/or the length of the article carrier at the transfer point by means of a detection device, preferably optically or by means of near-field communication,
generating the article identifier from the detected article code and/or the carrier identifier from the detected carrier code and/or the vehicle identifier from the detected vehicle code and/or the length identifier from the detected length by means of a computing unit downstream of the detection device, and
transmitting the generated article identifier and/or carrier identifier and/or vehicle identifier and/or length identifier to the central control device.

5. The method according to claim 2, characterized by:
storing a plurality of storage articles in a respective defined storage location,
taking out the plurality of storage articles, wherein the transport vehicles including the loaded article carriers are sorted during taking out and fed to the unloading station in a defined sequence, wherein the sequence is preferably defined by the central control device depending on the article identifier and/or carrier identifier and/or vehicle identifier and/or length identifier.

6. The method according to claim 1, characterized by:
autonomously driving and propelling the transport vehicles, at least for horizontal transportation along the network, in a time period between receiving a first control signal from the central control device and receiving a subsequent second control signal from the central control device.

7. The method according to claim 1, characterized in that the method is carried out in a hanging articles storage, wherein a hanging bag is used as an article carrier, a bag identifier is used as a carrier identifier.

8. A hanging articles storage, configured, designed and/or programmed for carrying out a method according to claim 1.

9. A hanging articles storage for storage articles to be stored hanging, according to claim 8, wherein the hanging articles storage comprises a number of levels, in each of which a network, in particular a rail network, is provided, and a plurality of self-propelled transport vehicles, each having an article carrier attached or attachable hanging thereto for receiving a storage article, which transport vehicles can be moved independently of one another along the network, characterized by:
a transfer point for transferring a storage article to be stored in the hanging articles storage to an article carrier attached to a transport vehicle,
means for generating an article identifier identifying the storage article and/or means for generating a carrier identifier identifying the article carrier and/or means for generating a vehicle identifier identifying the transport vehicle and/or means for generating a length identifier identifying a length of the article carrier, wherein the length of the article carrier in a state loaded with the storage article depends on the storage article,
a first system for vertically transporting the transport vehicle including the article carrier loaded with the storage article from the transfer point to a level of the hanging articles storage, in which a defined or definable storage location for the storage article is located,
a central control device which is configured to control the first system for vertically transporting the article carrier and the respective transport vehicle in such a way that the storage article can be stored in the defined or definable storage location, wherein the storage location is defined or definable depending on the article identifier and/or carrier identifier and/or vehicle identifier and/or length identifier.

10. The hanging articles storage according to claim 9, characterized by:
an unloading station for unloading a storage article to be taken out from the article carrier,
a second system for vertically transporting the transport vehicle, including the article carrier loaded with the storage article to be taken out, from the level of the hanging articles storage, in which the defined or definable storage location is located, to the unloading station,
wherein the central control device is configured to control the second system that vertically transports the article carrier and the transport vehicle of the article carrier loaded with the storage article in such a way that the transport vehicle, including the article carrier loaded with the storage article, can be fed from the defined or definable storage location to the unloading station.

11. The hanging articles storage according to claim 9, characterized in that:
a plurality of storage articles, each received on an article carrier, can be stored by of a plurality of transport vehicles at defined storage locations in a level or in different levels and can be taken out from the storage locations and fed sequentially to the unloading station,
wherein the central control device is configured to control the second system for vertically transporting the article carrier and the plurality of transport vehicles in such a way that the plurality of transport vehicles including the loaded article carriers are sorted during the taking out and can be fed to the unloading station in a defined sequence, wherein the sequence is preferably defined or can be defined depending on the article identifier and/or carrier identifier and/or vehicle identifier and/or length identifier.

12. The hanging articles storage according to ene of claim 9, characterized in that the means for generating the article identifier and/or the means for generating the carrier identifier and/or the means for generating the vehicle identifier and/or the means for generating the length identifier comprises at least one detection device, upstream of a computing unit, for detecting a machine-readable article code of the storage article and/or a machine-readable carrier code of the article carrier and/or a machine-readable vehicle code of the transport vehicle and/or the length of the article carrier, wherein the computing unit is connected data-technically to the central control device.

13. The hanging articles storage according to claim 12, characterized in that the computing unit has its own IP-address, via which the data-technical connection with the central control device can be established.

14. The hanging articles storage according to claim 12, characterized in that the detection device comprises at least one camera for optically detecting an optically readable article code, and/or an optically readable carrier code, and/or an optically readable vehicle code, and/or the length, wherein preferably one camera is provided in each case and a separate computing unit with a separate IP-address is provided downstream of each camera and/or in that the detection device comprises at least one reading unit for contactless reading of a contactless readable article code and/or a contactless readable carrier code and/or a contactless readable vehicle code, preferably based on nearfield communication, in particular NFC or RFID.

15. The hanging articles storage according to ene of claim 9, characterized in that the transport vehicles are configured to be moved and driven autonomously, at least for horizontal transport along the network, in a period between the receipt of a first control signal from the central control device and the receipt of a subsequent second control signal from the central control device.

16. The hanging articles storage according to claim 9, characterized in that the plurality of transport vehicles comprises at least two different vehicle types, wherein the vehicle types preferably differ in at least one of the following parameters: drive power, load capacity, fastening device for the article carrier, length in the direction of movement, height in the vertical direction.

17. The hanging articles storage according to claim 9, characterized by:
means for automated loading of an article carrier with a storage article at the transfer point, preferably comprising a stationary or mobile first handling robot, and/or
means for automated unloading of a storage article from an article carrier in the unloading station.

18. The hanging articles storage according to claim 9, characterized in that the first means for vertically transporting the article carriers comprises a first vertical conveyor and/or in that the second system that vertically transports the article carriers comprises a second vertical conveyor, wherein the first vertical conveyor and/or the second vertical conveyor preferably are configured as a ring conveyor system, in particular as a continuously conveying ring conveyor system.

19. The hanging articles storage according to claim 98, characterized in that the hanging articles storage is configured as a hanging bag storage, wherein the article carrier comprises a hanging bag, wherein the carrier identifier is a bag identifier and the carrier code is preferably a bag code.

20. The hanging articles storage according to claim 9, characterized in that a first level of the hanging articles storage or a first area of a level is assigned or assignable a number of defined or definable first article identifiers and/or first carrier identifiers and/or first vehicle identifiers and/or first length identifiers, and a second level or a second area of the level is assigned or assignable a number of defined or definable second article identifiers and/or second carrier identifiers and/or second vehicle identifiers- and/or second length identifiers, and in that the central control device is configured to define the storage locations for storage articles with first article identifiers and/or first carrier identifiers and/or first vehicle identifiers and/or first length identifiers in the first level or in the first area of the respective level and to define the storage locations for storage articles with second article identifiers and/or second carrier identifiers and/or second vehicle identifiers and/or second length identifiers in the second level or in the second area of the respective level.

21. A method for controlling a hanging articles storage for storage articles to be stored hanging, wherein the hanging articles storage comprises a number of levels, in each of which a network, and a plurality of self-propelled transport vehicles, each having an article carrier for receiving a storage article, the method comprising:
providing at a transfer point of the hanging articles storage and providing a transport vehicle with an article carrier,
loading the article carrier at the transfer point with the storage article,
generating an article identifier identifying the storage article and/or a carrier identifier identifying the article carrier and/or a vehicle identifier identifying the transport vehicle and/or a length identifier identifying a length of the article carrier, and
storing the storage article in the hanging articles storage by:
i. vertical transportation of the transport vehicle including the article carrier loaded with the storage article from the transfer point to a level of the hanging articles storage in which there is a defined or definable storage location for the storage article,
ii. horizontal transportation of the transport vehicle including the article carrier loaded with the storage article in another level to the defined or definable storage location, wherein the storage location is defined or is being defined depending on the article identifier and/or vehicle identifier and/or carrier identifier and/or length identifier.

22. A hanging articles storage for storage articles, wherein the hanging articles storage comprises:
a number of levels,
a plurality of self-propelled transport vehicles, each transport vehicle having an article carrier attached or attachable hanging thereto for receiving a storage article, which transport vehicles can be moved independently of one another,
a transfer point for transferring a storage article to be stored in the hanging articles storage to an article carrier attached to a transport vehicle,
a means for generating an article identifier identifying the storage article, and/or a means for generating a carrier identifier identifying the article carrier, and/or a means for generating a vehicle identifier identifying the transport vehicle, and/or means for generating a length identifier identifying a length of the article carrier, wherein the length of the article carrier in a state loaded with the storage article depends on the storage article,
a first means for vertically transporting the transport vehicle including the article carrier loaded with the storage article from the transfer point to a level of the hanging articles storage, in which a defined storage location for the storage article is located, and
a central control device which is configured to control the first means for vertically transporting the article carrier and the respective transport vehicle in such a way that the storage article can be stored in the defined or definable storage location, wherein the storage location is defined depending on the article identifier and/or carrier identifier and/or vehicle identifier and/or length identifier.
